(19) United States
(12) Patent Application Publication
(10) Pub. No.: US 2024/0275220 A1
(43) Pub. Date: Aug. 15, 2024

(54) STATOR CORE

(71) Applicant: TOYOTA JIDOSHA KABUSHIKI KAISHA, Toyota-shi (JP)

(72) Inventor: Takeshi TOMONAGA, Nisshin-shi (JP)

(73) Assignee: TOYOTA JIDOSHA KABUSHIKI KAISHA, Toyota-shi (JP)

(21) Appl. No.: 18/485,599

(22) Filed: Oct. 12, 2023

(30) Foreign Application Priority Data
Feb. 13, 2023 (JP) 2023-020260

(51) Int. Cl. H02K 1/16

(52) U.S. Cl. CPC H02K 1/16

(57) ABSTRACT

A stator core is composed of a stack of electrical steel sheets. Each electrical steel sheet includes a core back having an annular shape and teeth protruding inward in a radial direction of the annular shape from the core back. The core backs of the electrical steel sheets stacked in a range that is subjected to compressive stress from a coil end portion on the stator core has slits.

### CROSS-REFERENCE TO RELATED APPLICATION

This application claims priority to Japanese Patent Application No. 2023-020260 filed on Feb. 13, 2023 incorporated herein by reference in its entirety.

### BACKGROUND

### 1. Technical Field

The present disclosure relates to stator cores.

### 2. Description of Related Art

Japanese Unexamined Patent Application Publication No. 2010-226815 (JP 2010-226815 A) discloses a stator core in which slits for inserting heat conducting fins are formed between peripheral cores.

There is known a technique of forming a coil end portion made of resin on the upper part of a stator core in order to insulate terminal ends of coils. The coil end portion is formed by immersing end portions of the coils in hot resin.

### SUMMARY

In the case where the coil end portion is formed, the resin shrinks as the temperature of the resin decreases. As a result, compressive stress is applied to the stator core. When the compressive stress is applied, the iron loss increases and the output torque decreases.

In the stator core disclosed in JP 2010-226815 A, the slits are also formed in the lower part of the stator core that is not subjected to the compressive stress. The slits increase the magnetic resistance and reduce the output torque. In the stator core disclosed in JP 2010-226815 A, the compressive stress is applied to the portions where the cores contact each other. As a result, the output torque decreases.

The present disclosure was made in view of the above circumstances, and it is an object of the present disclosure to provide a stator core that can reduce a decrease in output torque.

A stator core according to the present disclosure is a stator core composed of a stack of electrical steel sheets. Each of the electrical steel sheets includes a core back having an annular shape and teeth protruding inward in a radial direction of the annular shape from the core back.

The core backs of the electrical steel sheets stacked in a range that is subjected to compressive stress from a coil end portion on the stator core has slits.

According to the present disclosure, it is possible to implement a stator core that can reduce a decrease in output torque.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a partially enlarged view of a stator core according to an embodiment;

FIG. 2 is a partially enlarged view of an electrical steel sheet in which slits are formed; and

FIG. 3 is a diagram showing loss due to stress applied from the coil end portion to the electrical steel sheets.

### DETAILED DESCRIPTION OF EMBODIMENTS

A stator core according to an embodiment of the present disclosure will be described with reference to the drawings. Components in the following embodiments include components that can be easily replaced by those skilled in the art, or components that are substantially the same.

### Configuration of Electrical Steel Sheets

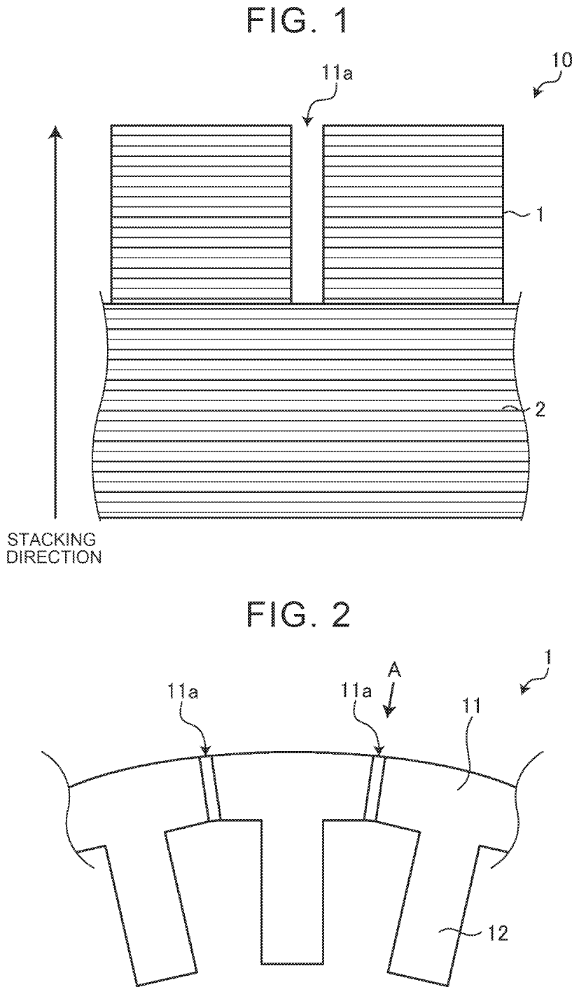

FIG. 1 is a partially enlarged view of a stator core according to the embodiment. A stator core 10 shown in FIG. 1 includes a plurality of electrical steel sheets 1 located in an upper layer in the stacking direction and having slits 11a formed therein, and a plurality of electrical steel sheets 2 located in a lower layer in the stacking direction and having no slit 11a formed therein. The stator core 10 is composed of a stack of the plurality of electrical steel sheets 1 and the plurality of electrical steel sheets 2. The electrical steel sheets 1, 2 are fixed to each other by, for example, caulking and welding.

The slits 11a are formed in the electrical steel sheets 1 stacked in a range that is subjected to compressive stress from the coil end portion formed on the stator core 10. The width of the slits 11a is adjusted so that the width becomes substantially zero due to thermal expansion of the electrical steel sheets 1 at the temperature at which the motor constructed using the stator core 10 is driven.

FIG. 2 is a partially enlarged view of an electrical steel sheet in which slits are formed. The A view in FIG. 2 corresponds to FIG. 1. As shown in FIG. 2, the electrical steel sheet 1 has a core back 11 having an annular shape and teeth 12 protruding inward in the radial direction of the annular shape from the core back 11. Slits 11a are formed in the core back 11 along the radial direction of the annular shape.

Here, coil end portions made of resin are formed on the upper portion of the stator core 10 in order to insulate the ends of the coil. The coil end portions are formed by immersing the ends of the coil in hot molten resin. Then, when the temperature of the resin drops from a high temperature to a low temperature, the resin contracts. At this time, since the stator core and the resin have different coefficients of thermal expansion, compressive stress is applied from the coil end portion to the inner peripheral side of the electrical steel sheets 1.

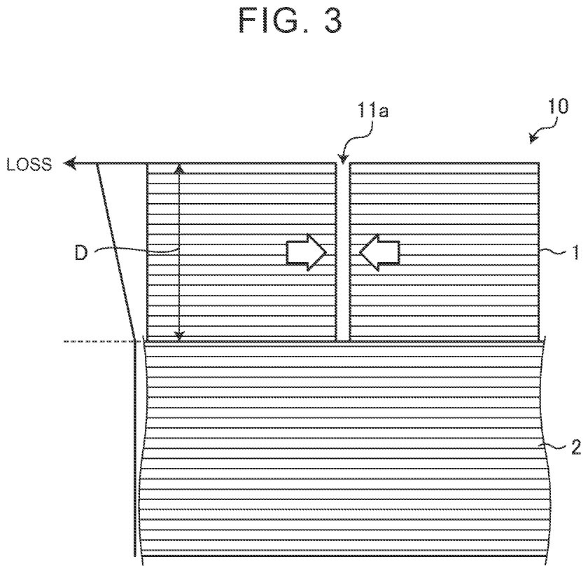

FIG. 3 is a diagram showing loss due to stress applied from the coil end portion to the electrical steel sheets. FIG. 3 shows the loss of a conventional stator core without slits. In FIG. 3, the lines on the left side of the diagram indicate that the further to the left the greater the loss. From the top end of the stator core to the position of depth D, compressive stress from the coil end portion is applied and the loss increases. Note that the closer to the upper end of the stator core, the greater the compressive stress from the coil end portion and the greater the loss. On the other hand, in the layer below the position of the depth D from the upper end of the stator core, no compressive stress is applied from the coil end portion, so the loss does not increase.

In the stator core 10, slits 11a are formed in the electrical steel sheets 1 stacked in a range (from the upper end of the stator core 10 to the position of the depth D) that is subjected to compressive stress from the coil end portion formed on the stator core 10. As a result, it is possible to suppress an increase in loss due to compressive stress from the coil end portion, and suppress a decrease in output torque.

In the stator core 10, no slit is formed in the electrical steel sheets 2 stacked in a range that is not subjected to compressive stress from the coil end portion formed on the stator core 10 (the layer located below the position of the depth D from the upper end of the stator core 10). As a result, an increase in magnetic resistance due to slits can be suppressed in the range where no loss resulting from compressive stress from the coil end portion occurs, and a decrease in output torque can be suppressed.

Further, in the stator core 10, the width of the slits 11a is adjusted so that the width becomes substantially zero due to the thermal expansion of the electrical steel sheets 1 at the temperature at which the motor constructed using the stator core 10 is driven. As a result, when the motor is driven, it is possible to suppress an increase in magnetic resistance due to the slits 11a and to suppress a decrease in output torque.

Further advantages and modifications can be easily derived by those skilled in the art. Therefore, the broader aspects of the disclosure are not limited to the specific details and representative embodiments shown and described above. Accordingly, various changes may be made without departing from the spirit or scope of the general inventive concept defined by the appended claims and equivalents thereof.

What is claimed is:

1. A stator core composed of a stack of electrical steel sheets, each of the electrical steel sheets including a core back having an annular shape and teeth protruding inward in a radial direction of the annular shape from the core back, wherein the core backs of the electrical steel sheets stacked in a range that is subjected to compressive stress from a coil end portion on the stator core has slits.

2. The stator core according to claim 1, wherein a width of the slits becomes substantially zero due to thermal expansion of the electrical steel sheets at a temperature at which a motor composed of the stator core is driven.
